(19) United States
(12) Patent Application Publication
(10) Pub. No.: US 2004/0217332 A1
(43) Pub. Date: Nov. 4, 2004

(54) Electrically conductive compositions and method for the production and use thereof

(76) Inventors: Reinhard Wagener, Hofheim (DE); Michael Haubs, Bad Kreuznach (DE); Arnold Schneller, Messel (DE)

Correspondence Address: CONNOLLY BOVE LODGE & HUTZ, LLP, P O BOX 2207, WILMINGTON, DE, 19899, US

(21) Appl. No.: 10/482,550

(22) PCT Filed: Jun. 27, 2002
(86) PCT No.: PCT/EP02/07111

(30) Foreign Application Priority Data
Jul. 4, 2001 (DE) 101 32 456.1

(51) Int. Cl. H01B 1/00

(52) U.S. Cl. 252/500

(57) ABSTRACT

Electrically conductive compositions and method for the production and use thereof

Electrically conductive compositions are described and are composed of selected thermoplastic polymers and of expanded graphite, the proportion by weight of the expanded graphite being less than 10% by weight, and the volume resistivity of the composition being at most 10¹⁰ ohm*cm.

A process is also described in which at least one thermoplastic polymer is prepared with expanded graphite by mixing the components in the liquid melt phase of the polymer at temperatures of from 150 to 400° C.

The invention relates to electrically conductive compositions comprising selected thermoplastic polymers, and also expanded graphite. In one preferred embodiment, the thermoplastic polymers belong to the group of the polyacetals, the cycloolefin copolymers, or the polyesters. The invention also relates to a selected process for preparing compositions in which thermoplastic polymers and expanded graphite are present.

For applications of plastics in electrical or electronic devices or workplaces it is often desirable that the plastics are electrically conductive. In the case of thermoplastic polymers, in particular polyacetals, polyamides, or polyesters, which have good mechanical and thermal properties, and also chemicals resistance, this can be achieved by adding carbon. The intrinsic conductivity of carbon (in the form of graphite, carbon black, or carbon fibers) is in principle sufficient to obtain the desired electromagnetic screening or dissipation of electrostatic charges.

CA 1 193 091 discloses electrically conductive compositions composed of polybutylene terephthalate with finely divided carbon. The desired electrical conductivity, above 10⁻¹⁰ S/cm (volume resistivity Ω<10¹⁰ ohm*cm) is achieved only if more than 10% by weight of carbon are present in the composite.

U.S. Pat. No. 4,351,745 discloses electrically conductive compositions composed of thermoplastic polyester elastomers in which more than 30% by weight of carbon is present in the form of a mixture of carbon black and graphite. It is said that graphite cannot be used by itself as conductivity additive.

JP-A-59-155,459 discloses electrically conductive compositions composed of polyethylene terephthalate with carbon black and graphite. The volume resistivity Ω achieved is <10¹⁰ ohm*cm only for more than 10% by weight of carbon.

JP-A-2000-143,956 discloses electrically conductive compositions composed of fully aromatic polyesters (polyarylates) with carbon black. The volume resistivity Ω achieved is <10¹⁰ ohm*cm only for more than 10% by weight of carbon.

U.S. Pat. No. 4,772,422 discloses electrically conductive compositions composed of liquid-crystalline polymers with carbon black, these having exceptionally low electrical resistance with as little as 1% by weight of carbon. This surprising effect is attributed to the particular direction-dependent properties present in the melts of the liquid-crystalline polymers, whereas the melts of conventional thermoplastics are isotropic.

JP-A-60-192,764 discloses an electrically conductive composition composed of a polyester resin thermoset with expanded graphite. The volume resistivity Ω achieved is <10⁸ ohm*cm in composites with 4% by weight of carbon.

Processes for preparing electrically conductive polyamide compositions are disclosed in Journal of Polymer Science: Part B: Polymer Physics, Vol. 38, 1626-1633 (2000) and in U.S. Pat No. 4,153,582. The processes relate to the polymerization of polyamide monomers in the presence of electrically conductive carbon. Journal of Polymer Science gives expanded graphite as an example of electrically conductive carbon.

EP-A-557,088 discloses electrically conductive compositions composed of a polyarylene sulfide, an alkoxysilane, and expanded graphite.

JP-A-07/11,063 discloses electrically conductive masterbatches which comprise a specific carbon black alongside a polyolefin.

WO-A-01/36,536 discloses conductive polyphenylene ether/polyamide mixtures in which talc and carbon are present. Carbon black and carbon fibers are listed as examples of carbon.

A common factor in many of the prior-art compositions mentioned is that more than 10% by weight of carbon has to be added in each instance in order to achieve the desired electrical conductivity values. Some documents certainly also describe compositions having electrically conductive additives in amounts of less 10% by weight, with high electrical conductivity. These compositions comprise polyamides which are prepared by polymerizing the monomers in the presence of the electrically conductive additive. Other previously known compositions comprise polyphenylene sulfides and expanded graphite, or polyesters or, respectively, polyesteramides which can form a liquid-crystalline phase, and carbon black.

Compositions have now been found which comprise selected polymers and in which high electrical conductivity can be achieved by adding small amounts of specific electrically conductive additives. These compositions may also be regarded as nanocomposites. The properties achievable are regarded as surprising because the compatibility of plastics and additives is not readily foreseeable here.

The inventive compositions also feature high toughness of the material, measurable as tensile strain at break or elongation, or Charpy or Izod impact strength.

It has also been found, surprisingly, that compositions comprising thermoplastic polymers and specific electrically conductive additives can be prepared through simple melt extrusion, and that compositions comprising polyarylene sulfides can also be prepared here without alkoxysilane additives.

An object of the present invention is the provision of selected electrically conductive polymer compositions which achieve volume resistivity Ω<10¹⁰ ohm*cm even when the carbon content is less than 10% by weight of additive.

Another object consists in providing selected electrically conductive polymer compositions with improved mechanical properties.

Another object consists in providing a simple preparation process for electrically conductive polymer compositions.

The present invention provides electrically conductive compositions comprising A) thermoplastic polymers, selected from the group consisting of polyolefins, such as polyethylene or polypropylene, polystyrene, polyalkylene halides, such as polyvinyl chloride or polyvinylidene chloride, cycloolefin copolymers, ABS copolymers, SAN copolymers, polyesters, polyimides, polyurethanes, polycarbonates, polyarylene ethers, polyetherimides, polyacetals, polyether ketones, poly(meth)acrylic acids, and derivatives of these, such as esters or amides, polyarylene sulfides, polysulfones, and polyether sulfones, and B) expanded graphite, the proportion by weight of the expanded graphite being less than 10% by weight, and the volume resistivity of the composition being at most 10¹⁰ ohm*cm, with the proviso that no alkoxysilanes are present in compositions comprising polyarylene sulfides.

One preferred embodiment of the invention provides electrically conductive compositions composed of thermoplastic polymers and of expanded graphite, the content of the expanded graphite being at most 6% by weight and preferably at most 4% by weight.

The volume resistivity Ω of the inventive compositions is preferably ≦10⁸ ohm*cm.

In one preferred embodiment, the thermoplastic polymers belong to the group of the polyacetals, cycloolefin copolymers, or the polyesters.

Alongside the expanded graphite, other forms of electrically conductive carbon may also be present in the inventive compositions. This carbon may be available in various forms.

By way of example, mention may be made of: flame black, conductivity black, naturally occurring graphite, carbon fibers, and carbon nanotubes.

The total amount of the additives which increase electrical conductivity in the invention composition is preferably less than 10% by weight, in particular less than 6% by weight, based on the composition.

According to the invention, the conductive carbon used at least comprises expanded graphite.

According to the prior art, expanded graphite can be prepared from naturally occurring graphite. By way of example, the procedure is that an intercalation compound is first prepared from naturally occurring graphite and a mixture of concentrated sulfuric acid and nitric acid, and this is dried. The dried intercalated compound is then rapidly heated to from 800 to 900° C. and thus expanded to give individual or substantially separate graphite Iamellae. The expanded graphite may then be ground to a desired particle size. The median particle size D₅₀ of the expanded graphite used to prepare the inventive compositions is at most 1 mm, preferably from 100 to 700 μm. The bulk density of the expanded graphite is usually up to 200 g/liter, preferably from 80 to 200 g/liter, in particular from 100 to 180 g/liter.

The thermoplastic polymers listed above may be used as component A) of the inventive composition. It is also possible to use mixtures or alloys of the polymers.

For the purposes of the invention, polyesters are any of the thermoplastic polymers and copolymers which can be obtained from aliphatic or cycloaliphatic diols, from aromatic diphenols, from aliphatic or cycloaliphatic, or aromatic dicarboxylic acids, or else from aliphatic or cycloaliphatic, or aromatic hydroxycarboxylic acids or from derivatives of these, where appropriate with addition of up to 20 mol % of other comonomers, such as amino alcohols or diisocyanates.

Preferred polyesters are liquid-crystalline polyesters, polyarylates, polyester elastomers, and also, particularly preferred, the partly aromatic polyesters of the type represented by polyethylene terephthalate (PET), polytrimethylene terephthalate (PTT), and polybutylene terephthalate (PBT). It is also possible to use mixtures or alloys or copolymers of the polyesters, with one another or with other polymers.

Liquid-crystalline polyesters melt anisotropically and form various types of liquid-crystalline melts. These liquid-crystalline melts have-low viscosity in a preferred direction. Typical representatives of the monomers used according to the prior art are terephthalic acid, isophthalic acid, 4-hydroxybenzoic acid, 1,4-dihydroxybenzene, 4,4′- and 3,4′-dihydroxybiphenyl, 6-hydroxy-2-naphthoic acid, 2,6-naphthalenedicarboxylic acid, or 4-amino-phenol, or else other compounds known from the literature whose polymerization under certain conditions and with precisely defined relationships results in the desired liquid-crystalline melt properties.

Polyarylates are isotropically melting polyesters composed of aromatic dicarboxylic acids and of aromatic diphenols, or of aromatic hydroxycarboxylic acids. Typical representatives of the monomers used according to the prior art are terephthalic acid, isophthalic acid, 3- and 4-hydroxybenzoic acid, 1,3- and 1,4-dihydroxybenzene, 4,4′- and 3,4′-dihydroxybiphenyl, 1,4-bis(hydroxymethyl)benzene, or bisphenol A, or else analogous compounds which derive from aromatic parent structures.

Polyester elastomers are copolymers composed of aromatic dicarboxylic acids, preferably terephthalic acid or isophthalic acid, with a mixture of short-chain and long-chain diols. Long-chain diols are oligomeric or polymeric glycols having terminal hydroxy groups. Typical representatives are polyethylene glycol, poly-1,2- or poly-1,3-propanediol, poly-1,4-butanediol or else random or block copolymers of these glycols or alkene oxides. Typical representatives of short-chain diols are ethylene glycol, 1,2-or 1,3-propanediol, or else 1,4-butanediol.

The particularly preferred partly aromatic polyesters likewise melt isotropically. They are copolymers composed of aromatic dicarboxylic acids, preferably terephthalic acid or terephthalic acid/isophthalic acid mixtures, with linear or branched aliphatic or cycloaliphatic diols having from 2 to 8, preferably from 2 to 4, carbon atoms. The most important representatives of the diols are ethylene glycol, 1,3-propanediol, and 1,4-butanediol. To obtain particular properties, use may be made of other comonomers, such as cyclohexanedimethanol or 1,4-bis(hydroxymethyl)-benzene, in molar proportions of up to 20%.

Suitable polyacetals are any of the known polyoxymethylenehomo- and copolymers. The polyoxymethylenes (POMs), for example as described in DE-A 29 47 490, are generally unbranched linear polymers which generally contain at least 80%, preferably at least 90%, of oxymethylene units (—CH₂O—). The term polyoxymethylenes here encompasses not only homopolymers of formaldehyde or of its cyclic oligomers, such as trioxane or tetroxane, but also corresponding copolymers.

Homopolymers of formaldehyde or of trioxane are polymers whose hydroxy end groups have been stabilized chemically in a known manner with respect to degradation, e.g. by esterification or etherification. Copolymers are polymers of formaldehyde or of its cyclic oligomers, in particular trioxane, with cyclic ethers, with cyclic acetals, and/or with linear polyacetals. Such POM homo- or copolymers are known per se to the skilled worker and have been described in the literature. Very generally, these polymers have at least 50 mol % of —CH₂O— repeat units in the main polymer chain. The homopolymers are generally prepared by polymerizing formaldehyde or trioxane, preferably in the presence of suitable catalysts.

For the purposes of the invention, POM copolymers are preferred as component (A), in particular those which besides the —CH₂O— repeat units also contain up to 50 mol %, preferably from 0.1 to 20 mol %, and in particular from 0.5 to 10 mol %, of repeat units

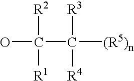

where R¹ to R⁴, independently of one another, are a hydrogen atom, a C₁-C₄-alkyl group, or a halogen-substituted alkyl group having from 1 to 4 carbon atoms, and R⁵ is —CH₂—, —O—CH₂—, a C₁-C₄-alkyl-substituted or C₁-C₄-haloalkyl-substituted methylene group, or a corresponding oxymethylene group, and n is a value in the range from 0 to 3.

These groups may advantageously be introduced into the copolymers via ring-opening of cyclic ethers.

Preferred cyclic ethers are those of the formula

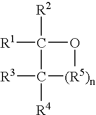

where R¹ to R⁵ and n are as defined above. Merely by way of example, mention may be made of ethylene oxide, propylene 1,2-oxide, butylene 1,2-oxide, butylene 1,3-oxide, 1,3-dioxane, 1,3-dioxalane, and 1,3-dioxepan as cyclic ethers, and also linear oligo- or polyformals, such as polydioxolane or polydioxepan as comonomers.

Copolymers of from 99.5 to 95 mol % of trioxane and from 0.5 to 5 mol % of one the abovementioned comonomers are particularly advantageous.

Oxymethylene terpolymers are also a suitable component (A) and are obtained, for example, by reacting trioxane with one of the above-described cyclic ethers and with a third monomer, preferably a bifunctional compound of the formula

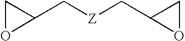

where Z is a chemical bond, —O—, or —ORO— (R=C₁-C₈-alkylene or C₂-C₈-cycloalkylene).

Preferred monomers of this type are ethylene diglycide, diglycidyl ether, and diethers composed of glycidyl units and formaldehyde, dioxane, or trioxane in a molar ratio of 2:1, and also diethers composed of 2 mol of glycidyl compound and 1 mol of an aliphatic diol having from 2 to 8 carbon atoms, for example the diglycidyl ethers of ethylene glycol, 1,4-butanediol, 1,3-butanediol, 1,3-cyclobutanediol, 1,2-propanediol, or 1,4-cyclohexane-diol, to mention just a few examples.

Processes for preparing the polyoxymethylene homo- and copolymers described above are known to the skilled worker and are described in the literature.

The preferred POM copolymers having melting points of at least 150° C. and molecular weights (weight-average) M_{w} in the range from 5000 to 200,000, preferably from 7000 to 150,000. Particular preference is given to end-group-stabilized POM polymers whose chain ends have carbon-carbon bonds. The POM polymers used generally have a melt index (MVR 190/2, 16) of from 2 to 50 cm³/10 min (ISO 1133).

For the purposes of the invention, cyclic olefin copolymers are copolymers composed of ethylene or propylene on the one hand, with cyclic olefins, containing from 0.1 to 100% by weight, preferably from 0.1 to 99.9% by weight, and particularly preferably from 3 to 75% by weight, based on the total weight of the cycloolefin polymer, of polymerized units of at least one cyclic olefin of the formulae I, II, II′, III, IV, V or VI

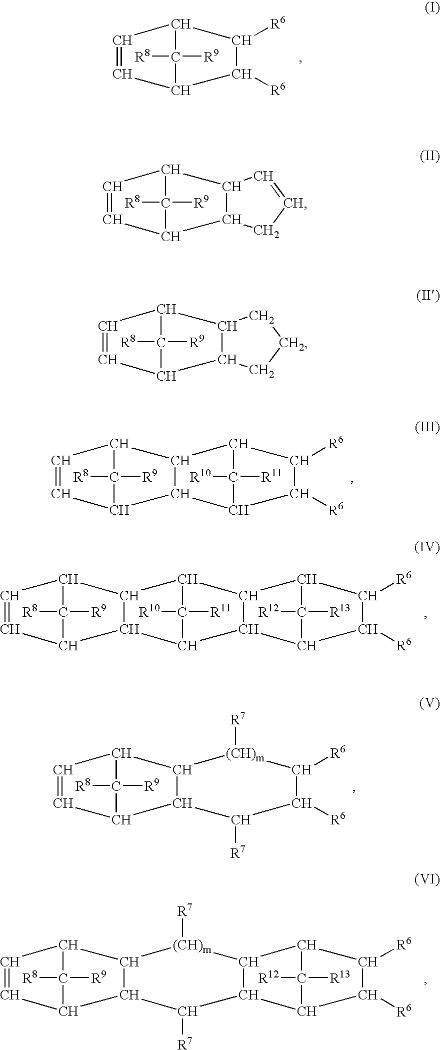

where R⁶, R⁷, R⁸, R⁹, R¹⁰, R¹¹, R¹², and R¹³ are identical or different and are a hydrogen atom or a C₁-C₂₀-hydrocarbon radical, such as a linear or branched C₁-C₈-alkyl radical, C₆-C₁₈-aryl radical, C₇-C₂₀-alkylenearyl radical, or a cyclic or acyclic C₂-C₂₀-alkenyl radical, or form a saturated, unsaturated, or aromatic ring, where the same radicals R⁶ to R¹³ in the various formulae I to VI may have a different meaning, and where m can assume values from 0 to 5, and containing from 0 to 99.9% by weight, preferably from 0.1 to 99.9% by weight, and particularly preferably from 5 to 80% by weight, based on the total weight of the cycloolefin polymer, of polymerized units which derive from one or more acyclic olefins of the formula VII

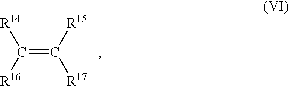

where R¹⁴, R¹⁵, R¹⁶, and R¹⁷ are identical or different and are a hydrogen atom, or a linear or branched, saturated or unsaturated C₁-C₂₀-hydrocarbon radical, such as a C₁-C₈-alkyl radical or a C₆-C₁₈-aryl radical.

The definition of cyclic olefins likewise includes derivatives of these cyclic olefins having polar groups, such as halo, hydroxy, ester, alkoxy, carboxy, cyano, amido, imido, or silyl groups.

The cycloolefin polymers used according to the invention may moreover contain from 0 to 45 mol %, based on the entire composition of the cycloolefin polymer, of polymerized units which derive from one or more monocyclic olefins of the formula VIII

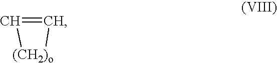

where o is a number from 2 to 10.

The cycloolefinic materials used for the purposes of this invention particularly preferably contain olefins with an underlying norbornene structure, and very particularly preferably contain norbornene and tetracyclododecene and, where appropriate, vinylnorbornene or norbornadiene.

Preference is also given to cycloolefin polymers which contain polymerized units which derive from acyclic olefins having terminal double bonds, such as α-olefins having from 2 to 20 carbon atoms, particularly preferably ethylene or propylene.

Very great preference is given to norbornene-ethylene copolymers and tetracyclododecene-ethylene copolymers.

Among the terpolymers, particular preference is given to norbornene-vinylnorbornene-ethylene terpolymers, norbornene-norbornadiene-ethylene terpolymers, tetracyclododecene-vinylnorbornene-ethylene terpolymers, and tetracyclododecene-vinyltetracyclododecene-ethylene terpolymers.

The proportion of the polymerized units which derive from a polyene, preferably vinylnorbornene or norbornadiene, is from 0.1 to 50 mol %, preferably from 0.1 to 20 mol %, and the proportion of the acyclic monoolefin of the formula VII is from 0 to 99.9 mol %, preferably from 5 to 80 mol %, based on the entire composition of the cycloolefin polymer.

The proportion of the polycyclic monoolefin in the terpolymers described is from 0.1 to 99.9 mol %, preferably from 3 to 75 mol %, based on the entire composition of the cycloolefin polymer.

EP-A-317262 describes other suitable polymers. Hydrogenated polymers and copolymers, e.g. of styrene or dicyclopentadiene, are expressly likewise suitable, and are likewise termed cycloolefin polymers for the purposes of this application.

Cycloolefin polymers based on comonomers such as ethylene and 2-norbornene are colorless, amorphous and transparent materials. The glass transition temperatures of the cycloolefin polymers may be adjusted within a wide range from −50 to 220° C. by varying the proportions of the comonomers and the average molecular weight. Preference is given to glass transition temperatures of from 0 to 180° C., and particular preference is given to glass transition temperatures of from 10 to 120° C.

The cycloolefin polymers described here have viscosity numbers of from 5 to 5000 ml/g to DIN 53 728. Preference is given to viscosity numbers of from 5 to 2000 ml/g, and viscosity numbers of from 5 to 1000 ml/g are particularly preferred.

Processes for preparing the cycloolefin copolymers described above by means of metallocene or Ziegler catalysis are known to the person skilled in the art and described in the literature.

Besides the electrically conductive carbon, other additives may be present in the polymers to control the property profile of the inventive compositions. The additives may be liquid or solid and have widely varying processing properties. Examples of processing properties are viscosity, density, or surface tension in the case of liquids, or grain size, grain shape, grain size distribution, hardness, flowability, adhesion, or bulk density in the case of solid additives. The additives give the polymer formulation the properties demanded in the respective application. By way of examples of the wide variety of additives known in the prior art, mention may be made of fillers which may be used and have the form of beads, fibers, or lamellae, with dimensions of from 10 nm to a few millimeters. They are primarily used to adjust the mechanical properties of the polymer formulation.

Examples of other additives are light stabilizers, in particular stabilizers with respect to UV and visible light; flame retardants; processing aids; pigments; lubricant additives and friction additives, e.g. polyethylene waxes and oxidized polyethylene waxes; adhesion promoters; impact modifiers; flow agents; mold-release agents; nucleating agents; acid scavengers and base scavengers; antioxidants; nitrogen-containing stabilizers; colorants; esters of polyhydric alcohols and fatty acids; metal salts of fatty acids; sterically hindered amines and phenol compounds; and also benzotriazole derivatives or benzophenone derivatives; nucleating agents, such as polyoxymethylene terpolymers or talc; fillers, such as glass beads, wollastonite, clay, or molybdenum disulfide; inorganic or organic fibers, such as glass fibers, carbon fibers, or aramid fibers; and thermoplastic or thermoset plastics additives or elastomers, e.g. polyethylene, polyurethane, polymethyl methacrylate, polybutadiene, polystyrene, or else graft copolymers whose core was prepared by polymerizing buta-1,3-diene, isoprene, n-butyl acrylate, ethylhexyl acrylate, or a mixture of these, and whose shell was prepared by polymerizing styrene, acrylonitrile, or (meth)acrylates. The amounts generally used of these additives are up to 40% by weight.

Other additives which may be used are colorants, such as any desired inorganic pigments, e.g. titanium dioxide, ultramarine blue, cobalt blue, or organic pigments and dyes such as phthalocyanines, anthraquinones, or carbon black, either individually or in the form of a mixture, or together with polymer-soluble dyes, in amounts which are generally from 0.1 to 5.0% by weight, preferably from 0.5 to 2.0%. Other additives which may be used are nitrogen-containing stabilizers. Nitrogen-containing stabilizers which are generally suitable are mostly heterocyclic compounds having at least one nitrogen atom as heteroatom, adjacent either to an amino-substituted carbon atom or to a carbonyl group, examples being pyridazihe, pyrimidine, pyrazine, pyrrolidone, aminopyridine, and compounds derived therefrom. Advantageous compounds of this generic type are aminopyridine and compounds derived therefrom. In principle, any of the aminpyridines is suitable, and examples of suitable compounds are melamine, 2,6-diamino-pyridine, and substituted and dimeric aminopyridines, and mixtures prepared from these compounds. Other advantageous compounds are polyamides and dicyandiamide, urea and its derivatives, and also pyrrolidone and compounds derived therefrom. Examples of suitable pyrrolidones are imidazolidinone and compounds derived therefrom, and examples of suitable compounds are hydantoin, the derivatives of which are particularly advantageous, and among these compounds allantoin and its derivatives are particularly advantageous. Other particularly advantageous compounds are triamino-1,3,5-triazine (melamine) and its derivatives, and examples of particularly advantageous compounds are melamine-formaldehyde condensates and methylolmelamine. Very particular preference is given to melamine, methylolmelamine, melamine-formaldehyde condensates, and allantoin. The nitrogen-containing stabilizers may be used individually or in combination, the amounts used of these compounds mostly being from 0.01 to 0.5%, preferably from 0.03 to 0.3%.

It is moreover possible to use esters composed of a polyhydric alcohol and of at least one fatty acid, in particular esters composed of higher fatty acids having from 10 to 32 carbon atoms, preferably from 24 to 32 carbon atoms, and polyhydric alcohols composed of from 2 to 8 carbon atoms, preferably from 2 to 5 carbon atoms. The acids do not have to have been entirely esterified, but may also have been only partially esterified, or the esters may have been partially hydrolyzed. Particularly preferred alcohols are ethylene glycol, glycerol, butylene glycol, and pentaerythritol, and among the fatty acids particular preference is given to montanic acids. Very particularly preferred esters are diesters composed of glycol or glycerol and montanic acids (Licowachs E and Licolub WE4, produced by Clariant AG).

Metal salts of a fatty acid may also be present in the inventive composition. Use may be made of alkali metal salts and of alkaline earth metal salts or of salts of other divalent metal ions, e.g. Zn²⁺, of long-chain fatty acids having from 10 to 32 carbon atoms, e.g. stearates, laurates, oleates, behenates, montanates, palmitates. The fatty acids may be either unsaturated or else saturated, and may also have substituent hydroxy or amino groups. Preference is given to the alkaline earth metal and zinc salts of stearic acid and of montanic acids, in particular magnesium stearate. The amounts of these compounds used in the compositions are mostly very small and often from 0.001 to 0.5% by weight, preferably from 0.01 to 0.2% by weight, particularly preferably from 0.01 to 0.1% by weight.

One or more sterically hindered phenol compounds may also be present in the inventive composition. Examples of commercially available compounds of this type are pentaerythrityl tetrakis[3-(3,5-di-tert-butyl-4-hydroxyphenyl)propionate] (Irganox 1010, Ciba Geigy), triethylene glycol bis[3-(3-tert-butyl-4-hydroxy-5-methylphenyl)propionate] (Irganox 245, Ciba Geigy), bis[3-(3,5-di-tert-butyl-4-hydroxyphenyl)propiono]hydrazide (Irganox MD. 1024, Ciba Geigy), hexamethylene glycol bis[3-(3,5-di-tert-butyl-4-hydroxyphenyl)propionate] (Irganox 259, Ciba Geigy), 3,5-di-tert-butyl-4-hydroxytoluene (Lowinox BHT, Great Lakes). The amounts of these compounds added to polymer compositions are mostly from 0.0 to 1.0% by weight, preferably from 0.0 to 0.4% by weight, particularly preferably from 0.0 to 0.1% by weight.

Furthermore, one or more stabilizers from the group of the benzotriazole derivatives or benzophenone derivatives, or aromatic benzoate derivatives may be present in the composition. Preference is given to 2-[2′-hydroxy-3′,5′-bis(1,1-dimethylbenzyl)phenyl]benzotriazole, which is obtainable commercially as Tinuvin 234 (Ciba Geigy). The amounts of these compounds mostly added to polymer compositions are from 0.0 to 1.0% by weight, preferably from 0.01 to 0.9% by weight, particularly preferably from 0.02 to 0.8% by weight.

One or more sterically hindered amines may also be present in the inventive composition for light stabilization (HALS). Preference is given to 2,2,6,6-tetramethyl-4-piperidyl compounds, e.g. bis(2,2,6,6-tetramethyl-4-piperidyl) sebacate (Tinuvin 770, Ciba Geigy) or the polymer composed of dimethyl succinate and 1-(2-hydroxyethyl)-4-hydroxy-2,2,6,6-tetramethyl-4-piperidine (Tinuvin 622, Ciba Geigy), the amounts of these generally used being from 0.0 to 0.5% by weight, preferably from 0.01 to 0.4% by weight, very particularly preferably 0.4% by weight.

The invention also provides a process for preparing the inventive electrically conductive compositions.

The inventive compositions may be prepared by mixing the components in the liquid melt phase of the polymer at temperatures of from 150 to 400° C., preferably from 200 to 350° C., and particularly preferably from 220 to 270° C. It is also possible to prepare compositions comprising polymers other than the thermoplastic polymers listed above, e.g. polyamides, by mixing the components in the liquid melt phase of the polymer at the abovementioned temperatures.

If use is made of polyarylene sulfides, such as polyphenylene sulfide, the use of alkoxysilanes here is excluded. It has been found that the inventive process leads to compositions with excellent properties even without the addition of these compounds.

This procedure implies a considerable simplification when compared with the known introduction of expanded graphite during the polymerization process.

The invention therefore also provides a process for preparing electrically conductive compositions, encompassing the mixing of A) at least one thermoplastic polymer and B) up to 10% by weight, based on the composition, of expanded graphite in the liquid or liquid-crystalline melt phase of the polymer at temperatures of from 150 to 400° C., preferably from 200 to 350° C., and particularly preferably from 220 to 270° C., with the proviso that the use of alkoxysilanes is excluded when polyarylene sulfides are used.

Suitable mixing assemblies are melt extruders of varied structural type, examples being single-screw extruders, and also counter-rotating or co-rotating twin-screw extruders. The pulverulent expanded graphite may be introduced into the extruder by way of a feed device downstream of the polymer-homogenizing zone. As. an alternative, where appropriate, expanded graphite may first be mixed together with further electrically conductive carbon and polymer powder or polymer pellets, and then introduced with the other materials into the homogenizing zone of the extruder.

One preferred embodiment begins by preparing a composition, known as a masterbatch, with relatively high carbon content. The proportion by weight of the carbon in the masterbatch is from 6 to 25% by weight, preferably from 8 to 20% by weight.

The inventive process is then carried out with at most 6% by weight, preferably at most 4% by weight, of expanded graphite, by coextruding the masterbatch with polymer.

However, another possible method carries out the inventive process directly, i.e. through single-stage extrusion of thermoplastic polymer with expanded graphite in the inventive quantitative proportions.

The inventive compositions are suitable for producing moldings which are used in explosion-risk surroundings, or moldings during whose use the accumulation of electrical charges has to be avoided. Examples here are the use as a tank filler neck, as a conveyor component in explosion-risk surroundings, for example in mines, or the use in automatic teller machines. The invention also provides the uses of the compositions for these purposes.

The examples below illustrate the invention but do not restrict the same.

### EXAMPLE 1

### Preparation of a Polyester Masterbatch

A mixture composed of 75% by weight of polybutylene terephthalate powder (Celanex CX2003, Ticona GmbH, Frankfurt am Main) and 25% by weight of expanded graphite (Conductograph GFG 50M, SGL Carbon GmbH, Meitingen) was weighed out and homogenized on a roller bed. The mixture was kneaded for 15 minutes in the melt at 250° C. in a melt kneader (Haake Rheocord System 90). The cooled melt was ground.

### Preparation of Inventive Compositions from the Masterbatch

The polybutylene terephthalate masterbatch produced was weighed out in the quantitative proportions stated in Table 1 with PBT, and mixed on a roller bed.

TABLE 1

| | Parts by | Parts by | Resultant |
|---|---|---|---|
| | weight of | weight | proportion of |
| Specimen | masterbatch | of | graphite in entire |
| No. | (Example 1) | CX2003 | mixture |
| 1a | 2 | 48 | 1.0% by weight |
| 1b | 4 | 46 | 2.0% by weight |
| 1c | 8 | 42 | 4.0% by weight |

The mixtures were kneaded in the melt at 250° C. for 15 minutes in a melt kneader (Haake Rheocord System 90). The cooled melts were ground.

### EXAMPLE 2

### Direct Preparation of Inventive Compositions

Expanded graphite and PBT were weighed out in the quantitative proportions stated in Table 2 and mixed on a roller bed.

TABLE 2

| | Parts by | Parts by | Resultant |
|---|---|---|---|
| | weight of | weight | proportion of |
| Specimen | expanded | of | graphite in entire |
| No. | graphite | CX2003 | mixture |
| 2 | 4.0 | 96.0 | 4.0% by weight |

The mixtures were kneaded in the melt at 250° C. for 15 minutes in a melt kneader (Haake Rheocord System 90). The cooled melts were ground.

### EXAMPLE 3 AND COMPARATIVE EXAMPLE 1

Polybutylene terephthalate was weighed out with expanded graphite or with the polybutylene terephthalate masterbatch in the quantitative proportions stated in Table 3, and mixed on a roller bed.

TABLE 3

| | Parts by | Parts by | | Resultant |
|---|---|---|---|---|
| | weight of | weight of | Parts by | proportion of |
| Specimen | masterbatch | expanded | weight of | graphite in entire |
| No. | (Example 1) | graphite | CX2003 | mixture |
| 3a | 16 | 0 | 34 | 8.0% by weight |
| Comp 1a | 30 | 0 | 20 | 15.0% by weight |
| 3b | 0 | 8.0 | 92.0 | 8.0% by weight |
| Comp b | 0 | 15.0 | 85.0 | 15.0% by weight |

The mixtures were kneaded in the melt at 250° C. for 15 minutes in a melt kneader (Haake Rheocord System 90). The cooled melts were ground.

### EXAMPLE 4

### Preparation of a Polyamide Masterbatch

A mixture composed of 75% by weight of polyamide powder (Celanese nylon-6,6, Ticona GmbH, Frankfurt am Main) and 25% by weight of expanded graphite (Conductograph GFG 50 M, SGL Carbon GmbH, Meitingen) was weighed out and homogenized on a roller bed. The mixture, was kneaded in the melt at 290° C. for 15 minutes in a melt kneader (Haake Rheocord System 90). The cooled melts were ground.

### Inventive Preparation of Electrically Conductive Compositions from the Polyamide Masterbatch

The polyamide masterbatch prepared in example 4 was weighed out in the quantitative proportions stated in Table 4 with nylon-6,6 and mixed on a roller bed.

TABLE 4

| | Parts by | Parts by | Resultant |
|---|---|---|---|
| | weight of | weight | proportion of |
| Specimen | masterbatch | of Celanese | graphite in entire |
| No. | (Example 5) | nylon-6,6 | mixture |
| 4 | 8 | 42 | 4.0% by weight |

The mixtures were kneaded in the melt at 280° C. for 15 minutes in a melt kneader (Haake Rheocord System 90). The cooled melts were ground.

### EXAMPLE 5 AND COMPARATIVE EXAMPLE 2

Nylon-6,6 was weighed out with expanded graphite or with the polyamide masterbatch in the quantitative proportions stated in Table 5, and mixed on a roller bed.

TABLE 5

| | Parts by | Parts by | Parts by | Resultant |
|---|---|---|---|---|
| | weight of | weight of | weight of | proportion of |
| Specimen | masterbatch | expanded | Celanese | graphite in entire |
| No. | (Example 5) | graphite | nylon-6,6 | mixture |
| 5a | 16 | 0 | 34 | 8.0% by weight |
| Comp 2a | 30 | 0 | 20 | 15.0% by weight |
| 5b | 0 | 8.0 | 92.0 | 8.0% by weight |

The mixtures were kneaded in the melt at 280° C. for 15 minutes in a melt kneader (Haake Rheocord System 90). The cooled melts were ground.

### EXAMPLE 6

### Determination of Volume Resistivity

The compositions prepared in examples 1 to 5, and also in comparative examples 1 and 2, were pressed in a vacuum press at 250° C. (PBT specimens from examples 1, 2, 3, and comp 1) or 280° C. (nylon-6,6 specimens from examples 4, 5 and comp 2) to give disks of diameter 120 mm and thickness 1 mm. The volume resistivity of the disks was determined over a circle diameter of 50 mm. The volume resistivity was determined to IEC 60093, as in VDE 0303 part 30.

TABLE 6
Volume resistivity for the specimens from examples 1 to 5 and
comparative examples 1 and 2

| | Specimen No. | | | |
|---|---|---|---|---|
| | 1a | 1b | 1c | 2 |
| Volume resistivity | 1.8 * 10⁴ | 9.2 * 10⁶ | 1.7 * 10⁷ | 9.6 * 10⁵ |
| [ohm * cm] | | | | |
| | Specimen No. | | | |
| | 3a | comp 1a | 3b | comp 1b |
| Volume resistivity | 6.2 * 10² | 4.3 * 10⁴ | 1.3 * 10³ | 2.4 * 10⁵ |
| [ohm * cm] | | | | |
| | Specimen No. | | | |
| | 4 | 5a | comp 2a | 5b |
| Volume resistivity | 9.0 * 10⁶ | 2.0 * 10⁶ | 1.7 * 10⁵ | 2.1 * 10⁶ |
| [ohm * cm] | | | | |

### EXAMPLE 7

A suitably stabilized pblyacetal copolymer was weighed out in the quantitative proportions stated in Table 7 with expanded graphite (Conductograph GFG 500M, SGL Carbon GmbH, Meitingen, median grain diameter d₅₀=400 μm), and mixed on a roller bed. The mixture was kneaded in the melt at 200° C. for 15 minutes in a melt kneader (Haake Polylab). The cooled melts were ground.

The resultant compositions were pressed in a vacuum press at 210° C. to give disks of diameter 120 mm and thickness 1 mm. The volume resistivity of the disks was measured over a circle diameter of 50 mm. The volume resistivity was determined to IEC 60093, as in VDE 0303 part 30.

Table 7 gives the results.

TABLE 7

| | Proportion by weight | Volume |
|---|---|---|
| Specimen | of expanded graphite | resistivity |
| No. | in mixture | [ohm * cm] |
| 7a | 2.0% by weight | 2.7 * 10⁷ |
| 7b | 4.0% by weight | 7.0 * 10³ |
| 7c | 6.0% by weight | 4.1 * 10² |

### EXAMPLE 8

A suitably stabilized polyacetal copolymer was weighed out in the quantitative proportions stated in Table 8 with conductivity black and with expanded graphite (Conductograph GFG 500M, SGL Carbon GmbH, Meitingen, median grain diameter d₅₀=400 μm), and mixed on a roller bed. The mixture was kneaded in the melt at 200° C. for 15 minutes in a melt kneader (Haake Polylab). The cooled melts were ground.

The resultant compositions were pressed in a vacuum press at 210° C. to give disks of diameter 120 mm and thickness 1 mm. The volume resistivity of the disks was measured over a circle diameter of 50 mm. The volume resistivity was determined to IEC 60093, as in VDE 0303 part 30.

Table 8 gives the results.

TABLE 8

| | Proportion by | Proportion by | |
|---|---|---|---|
| | weight of | weight of | Volume |
| Specimen | expanded | conductivity | resistivity |
| No. | graphite | black | [ohm * cm] |
| 8a | 1.0% by weight | 1.0% by weight | 4.8 * 10⁴ |
| 8b | 2.0% by weight | 1.0% by weight | 4.8 * 10³ |
| 8c | 3.0% by weight | 1.0% by weight | 2.4 * 10³ |

### EXAMPLE 9

A suitably stabilized polyacetal copolymer was weighed out in the quantitative proportions stated in Table 9 with conductivity black and with expanded graphite (Conductograph GFG 700M, SGL Carbon GmbH, Meitingen, median grain diameter d₅₀=800 μm), and mixed on a roller bed. The mixture was kneaded in the melt at 200° C. for 15 minutes in a melt kneader (Haake Polylab). The cooled melts were ground.

The resultant compositions were pressed in a vacuum press at 210° C. to give disks of diameter 120 mm and thickness 1 mm. The volume resistivity of the disks was measured over a circle diameter of 50 mm. The volume resistivity was determined to IEC 60093, as in VDE 0303 part 30.

Table 9 gives the results.

TABLE 9

| | Proportion by | Proportion by | |
|---|---|---|---|
| | weight of | weight of | Volume |
| Specimen | expanded | conductivity | resistivity |
| No. | graphite | black | [ohm * cm] |
| 9a | 1.0% by weight | 1.0% by weight | 1.3 * 10⁴ |
| 9b | 2.0% by weight | 1.0% by weight | 2.8 * 10³ |
| 9c | 3.0% by weight | 1.0% by weight | 1.3 * 10³ |

### EXAMPLE 10

A mixture composed of the proportions by weight stated in Table 10 of polyphenylene sulfide (Fortron® 0214, Ticona GmbH, Frankfurt am Main) and of expanded graphite (Conductograph GFG 500M or GFG 700M, SGL Carbon GmbH, Meitingen) was weighed out together with the additives listed in Table 10 and homogenized on a roller bed. The mixtures were kneaded in the melt at 300° C. for 15 minutes in a melt kneader (Haake Polylab). The cooled melts were ground.

TABLE 10

| | | | | | Proportion |
|---|---|---|---|---|---|
| | Proportion | Proportion | Proportion | Proportion by | by weight of |
| | by weight of | by weight of | by weight of | weight of | biphenyl |
| | Fortron 214 | GFG 700M | GFG 500M | benzophenone | sulfone in |
| Specimen No. | in mixture | in mixture | in mixture | in mixture | mixture |
| 10a | 85.0% by | | 15.0% by | | |
| | weight | | weight | | |
| 10b | 85.0% by | 15.0% by | | | |
| | weight | weight | | | |
| 10c | 85.0% by | | 13.5% by | 1.5% by | |
| | weight | | weight | weight | |
| 10d | 85.0% by | | 13.5% by | | 1.5% by |
| | weight | | weight | | weight |
| 10e | 85.0% by | 13.5% by | | | 1.5% by |
| | weight | weight | | | weight |

The resultant polyphenylene sulfide masterbatches were weighed out in the quantitative proportions stated in Table 11 with further Fortron 214 and mixed on a roller bed. The mixtures were kneaded in the melt at 300° C. for 15 minutes in a melt kneader (Haake Polylab). The cooled melts were ground.

No silane-based coupling agent was used either for preparing the masterbatches 10a-10e (Table 10) or for preparing the compositions 10f-10o (Table 11).

The resultant compositions were pressed in a vacuum press at 310° C. to give disks of diameter 120 mm and thickness 1 mm. The volume resistivity of the disks was measured over a circle diameter of 50 mm. The volume resistivity was determined to IEC 60093, as in VDE 0303 part 30.

The volume resistivity values are likewise found in Table 11.

TABLE 11

| | | | Parts by | Resultant | Resultant |
|---|---|---|---|---|---|
| | | Parts | weight of | proportion of | volume |
| | Masterbatch | by weight of | Fortron | graphite in | resistivity |
| Specimen No. | type | masterbatch | 214 | entire mixture | [ohm * cm] |
| 10f | 10a | 10 | 50 | 2.5% by weight | 4.6 * 10⁵ |
| 10g | 10a | 20 | 40 | 5.0% by weight | 3.5 * 10⁵ |
| 10h | 10b | 10 | 50 | 2.5% by weight | 2.0 * 10⁶ |
| 10i | 10b | 20 | 40 | 5.0% by weight | 9.5 * 10⁵ |
| 10j | 10c | 10 | 50 | 2.25% by weight | 4.2 * 10⁶ |
| 10k | 10c | 20 | 40 | 4.5% by weight | 8.4 * 10⁵ |
| 10l | 10d | 10 | 50 | 2.25% by weight | 2.4 * 10⁶ |
| 10m | 10d | 20 | 40 | 4.5% by weight | 1.0 * 10⁶ |
| 10n | 10e | 10 | 50 | 2.25% by weight | 3.2 * 10⁹ |
| 10o | 10e | 20 | 40 | 4.5% by weight | 1.9 * 10⁵ |

### EXAMPLE 11

A suitably stabilized ethylene-norbornene copolymer was weighed out in the quantitative proportions stated in Table 12 with expanded graphite (Conductograph GFG 500M, SGL Carbon GmbH, Meitingen, median grain diameter d₅₀=400 μm) and mixed on a roller bed. The mixture was kneaded in the melt at 200° C. for 15 minutes in a melt kneader (Haake Polylab). The cooled melts were ground.

The resultant compositions were pressed in a vacuum press at 210° C. to give disks of diameter 120 mm and thickness 1 mm. The volume resistivity of the disks was measured over a circle diameter of 50 mm. The volume resistivity was determined to IEC 60093, as in VDE 0303 part 30.

Table 12 gives the results.

TABLE 12

| | Proportion by | Volume |
|---|---|---|
| Specimen | weight of expanded | resistivity |
| No. | graphite in mixture | [ohm * cm] |
| 11a | 2.5% by weight | 3.9 * 10⁶ |
| 11b | 3.75% by weight | 1.4 * 10⁶ |

1-17 cancelled

18. An electrically conductive composition comprising
A) thermoplastic polymers selected from the group consisting of
polyolefins,
polystyrenes,
polyalkylene halides,
cycloolefin copolymers,
ABS copolymers,
SAN copolymers,
polyesters,
polyimides,
polyurethanes,
polycarbonates,
polyarylene ethers,
polyetherimides,
polyacetals,
polyether ketones,
poly(meth)acrylic acids, and
derivatives of the above polymers,
B) expanded graphite, and
C) other forms of electrically conductive carbon, the proportion by weight of the additives which increase electrical conductivity being less than 6% by weight, based on the composition, and the volume resistivity of the composition being at most 10¹⁰ ohm*cm, with the proviso that no alkoxysilanes are present in compositions comprising polyarylene sulfides.

19. The composition as claimed in claim 18, wherein said derivatives of the above polymers are esters or amides, polyarylene sulfides, polysulfones, or polyether sulfones, and
said other forms of electrically conductive carbon are flame black, conductivity black, naturally occurring graphite, carbon fibers, or carbon nanotubes,

20. The composition as claimed in claim 18, wherein the proportion by weight of the additives which increase electrical conductivity is at most 4% by weight.

21. The composition as claimed in claim 18, whose volume resistivity is at most 10⁸ ohm*cm.

22. The composition as claimed in claim 18, wherein the median particle size of the expanded graphite used is at most 1 mm.

23. The composition as claimed in claim 18, wherein the bulk density of the expanded graphite used is at most 200 g/liter.

24. The composition as claimed in claim 18, wherein the bulk density of the expanded graphite used is at most 150 g/liter.

25. The composition as claimed in claim 18, wherein the thermoplastic polymers are selected from the group consisting of polyacetals, cycloolefin copolymers and polyesters.

26. The composition as claimed in claim 18, wherein the thermoplastic polymers are the polyesters and the polyesters are selected from the group of the liquid-crystalline polyesters, polyarylates, polyester elastomers, or partly aromatic polyesters, and also their mixtures and alloys.

27. The composition as claimed in claim 25, wherein the thermoplastic polymers are the polyesters and the polyesters are isotropically melting polyesters.

28. The composition as claimed in claim 25, wherein the thermoplastic polymers are the polyesters and the polyesters are substantially composed of polyethylene terephthalate and/or of polytrimethylene terephthalate and/or of polybutylene terephthalate.

29. The composition as claimed in claim 25, wherein the thermoplastic polymers are the polyacetals and the polyacetals are selected from the group of poly(oxymethylene) homopolymers and poly(oxymethylene) copolymers.

30. The composition as claimed in claim 18, which further comprises other additives which are selected from the group consisting of light stabilizers; flame retardants; processing aids; pigments; lubricant additives; friction additives, adhesion promoters; impact modifiers; flow agents; mold-release agents; acid scavengers; base scavengers; antioxidants; nitrogen-containing stabilizers; colorants; esters of polyhydric alcohols and fatty acids; metal salts of fatty acids; sterically hindered amines and phenol compounds; benzotriazole derivatives; benzophenone derivatives; nucleating agents; fillers, inorganic fibers; organic fibers; thermoplastic plastics additives; thermoset plastics additives; elastomers; and graft copolymers whose core was prepared by polymerizing buta-1,3-diene, isoprene, n-butyl acrylate, ethylhexyl acrylate, or a mixture of these, and whose shell was prepared by polymerizing styrene, acrylonitrile, or (meth)acrylates.

31. The composition as claimed in claim 31, wherein said other additives are stabilizers with respect to UV and visible light; polyethylene waxes, oxidized polyethylene waxes; glass beads, talc; wollastonite, clay, molybdenum disulfides; glass fibers, carbon fibers, aramid fibers; polyethylenes, polyurethanes, polymethyl methacrylates, polybutadienes, polystyrenes or polyoxymethylene terpolymers.

32. A process for preparing electrically conductive compositions, encompassing the mixing of components A) to C) as claimed in claim 18 in the liquid or liquid-crystalline melt phase of the polymer at temperatures of from 150 to 400° C.

33. The process as claimed in claim 32, wherein the temperatures are from 200 to 350° C.

34. The process as claimed in claim 32, wherein the temperatures are from 220 to 270° C.

35. The process as claimed in claim 32, wherein the thermoplastic polymer is selected from the group consisting of polyolefins, polystyrenes, polyalkylene halides, cycloolefin copolymers, ABS copolymers, SAN copolymers, polyesters, polyamides, polyimides, polyurethanes, polycarbonates, polyarylene ethers, polyetherimides, polyphenylene sulfides, polyacetals, polyether ketones, poly(meth)acrylic acids, and derivatives of these.

36. The process as claimed in claim 35, wherein the thermoplastic polymer is the derivative of these and are esters or amides, polyarylene sulfides, polysulfones, or polyether sulfones.

37. The process as claimed in claim 32, wherein an extruder is used as mixing assembly.

38. The process as claimed in claim 32, wherein a masterbatch with a relatively high proportion by weight of additives which increase electrical conductivity is first prepared, and then the masterbatch is coextruded with thermoplastic polymer.

39. The process as claimed in claim 38, wherein the proportion by weight of the expanded graphite in the masterbatch is from 6 to 25% by weight.

40. The process as claimed in claim 38, wherein the proportion by weight of the expanded graphite in the masterbatch is from 8 to 20% by weight.

41. An article which comprises using the composition as claimed in claim 18, wherein the article is in the form of a tank filler neck, in the form of conveyor components in environments with explosion risk, or in the form of a component in automatic teller machines.
